(19) United States
(12) Patent Application Publication
(10) Pub. No.: US 2025/0021881 A1
(43) Pub. Date: Jan. 16, 2025

(54) TRAINING DATASET UPDATES FOR A TRAINING DATASET PARTITIONED INTO MULTIPLE DATASET GROUPS

(71) Applicant: Lenovo (Singapore) Pte. Limited, Singapore (SG)

(72) Inventors: Ahmed Hindy, Aurora, IL (US); Vahid Pourahmadi, München (DE); Venkata Srinivas Kothapalli, Ottawa (CA); Vijay Nangia, Woodridge, IL (US)

(73) Assignee: Lenovo (Singapore) Pte. Limited, Singapore (SG)

(21) Appl. No.: 18/769,061

(22) Filed: Jul. 10, 2024

Related U.S. Application Data
(60) Provisional application No. 63/526,531, filed on Jul. 13, 2023.

(51) Int. Cl. G06N 20/00

(52) U.S. Cl. CPC G06N 20/00

(57) ABSTRACT

Various aspects of the present disclosure relate to training dataset updates. A training dataset is partitioned into multiple dataset groups and each dataset group includes one or more training datapoints. Each dataset group is associated with a first label and a second label. The first label corresponds to a temporal or time-domain related parameter, such as a time stamp or a time duration. The second label is at least one of a weight or a value associated with a characteristic of the dataset. The training dataset is updated based on at least one of the first label or the second label, such as by updating a subset of values of the second label, removing a dataset group, or adding a new dataset group to the training dataset. Updated information corresponding to the updated training dataset can then be sent from one device to another.

### RELATED APPLICATION

This application claims priority to U.S. patent application Ser. No. 63/526,531 filed Jul. 13, 2023 entitled “TRAINING DATASET UPDATES FOR A TRAINING DATASET PARTITIONED INTO MULTIPLE DATASET GROUPS,” the disclosure of which is incorporated by reference herein in its entirety.

### TECHNICAL FIELD

The present disclosure relates to wireless communications, and more specifically to partitioning a training dataset into multiple dataset groups.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Artificial intelligence or machine learning (AI/ML) techniques may be used to implement various aspects of the wireless communications system. An AI/ML system or algorithm can be initially trained to generate certain information. Additional data may be collected over time and the AI/ML system or algorithm can be retrained based on the additional data.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include to: transmit, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; update the second label after transmission of the first signaling; update the training dataset, based on at least one of the first label or the second label, by at least one of updating a subset of values of the second label of the multiple dataset groups, removing a dataset group of the multiple dataset groups, or adding a new dataset group to the dataset; and transmit, to the network equipment over the physical channel, a second signaling indicating a second training dataset report that includes updated information corresponding to the updated training dataset.

Some implementations of the method and apparatuses described herein may further include to: receive, from a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receive, from the network equipment over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Some implementations of the method and apparatuses described herein may further include to: transmit, to a user equipment (UE) over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; update the second label after transmission of the first signaling; update the training dataset, based on at least one of the first label or the second label, by at least one of updating a subset of values of the second label of the multiple dataset groups, removing a dataset group of the multiple dataset groups, or adding a new dataset group to the dataset; and transmit, to the UE over the physical channel, a second signaling indicating a second training dataset report that includes updated information corresponding to the updated training dataset.

Some implementations of the method and apparatuses described herein may further include to: receive, from a user equipment (UE) over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receive, from the UE over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

In some implementations of the method and apparatuses described herein, the physical channel is an uplink channel. Additionally or alternatively, a number of the multiple dataset groups is bounded by a maximum value of a number of dataset groups. Additionally or alternatively, the temporal or time-domain related parameter is at least one of a time stamp or a time duration. Additionally or alternatively, the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof. Additionally or alternatively, the weight of the dataset group is selected from a codebook of values associated with the weight. Additionally or alternatively, the weight of the dataset group is updated based on an event and the event is: based on a configuration for updating the dataset, one of a periodic or a semipersistent event; triggered by at least one of a network configuration signal, a downlink control information, or a medium access control control element (MAC-CE) signal; or a combination thereof. Additionally or alternatively, the training dataset is updated by replacing a dataset group associated with a smaller value of weight with a dataset group associated with a larger value of the weight. Additionally or alternatively, a dataset group associated with a time stamp corresponding to a former value is replaced with a dataset group associated with a time stamp corresponding to a more recent value. Additionally or alternatively, a dataset point is associated, based on one or more characteristics of the dataset point, with a dataset group of the multiple dataset groups. Additionally or alternatively, the dataset point is associated with the dataset group of the multiple dataset groups based on an artificial intelligence (AI)-based model maintenance process. Additionally or alternatively, a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points. Additionally or alternatively, the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset. Additionally or alternatively, the training dataset corresponds to at least one of channel state information (CSI), precoding information, or beam-based information, and wherein a first dataset group of the multiple dataset groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, wherein a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, a power-delay profile associated with the CSI, or an unobservable characteristic of the CSI that is based on an observable characteristic. Additionally or alternatively, the observable characteristic is one or more of a flag on whether a channel associated with the CSI corresponds to a line-of-sight (LoS) or non-line-of-sight (NLoS) channel based on a number of dominant basis indices of a transformed frequency-domain basis, the dominant basis indices corresponding to indices with a minimum power threshold. Additionally or alternatively, the training dataset corresponds to positioning information, and wherein a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, wherein a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic. Additionally or alternatively, the observable characteristic is one or more of a flag on whether a channel associated with the positioning information corresponds to an indoor or outdoor UE based on one or more of the values of the angle of arrival, the angle of departure, the round-trip time, or the time-difference of arrival. Additionally or alternatively, the training dataset corresponds to mobility information, and wherein a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, wherein a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of reference signal received power (RSRP), signal-to-interference-and-noise ratio (SINR), beam-based information, channel state information (CSI), or an unobservable characteristic of the mobility information that is based on an observable characteristic. Additionally or alternatively, the observable characteristic is a flag on whether the UE is associated with a best cell based on one or more of values of the RSRP, values of the SINR, beam-based information, or CSI.

In some implementations of the method and apparatuses described herein, the physical channel is a downlink channel. Additionally or alternatively, the event is triggered by at least one of a UE-based signal over an uplink control information or multiplexed with a CSI report.

### BRIEF DESCRIPTION OF THE DRAWINGS

FIG. 1 illustrates an example of a wireless communications system in accordance with aspects of the present disclosure.

FIG. 2 illustrates an example of training dataset updates in accordance with aspects of the present disclosure.

FIGS. 3 through 6 illustrate examples of matrices as related to channel state information reporting using mixed reference signal types.

FIG. 7 illustrates an example of aperiodic trigger state defining a list of CSI Report Settings.

FIG. 8 illustrates an example of aperiodic trigger state.

FIG. 9 illustrates an example of RRC configuration for a non-zero power (NZP) CSI reference signal (RS) Resource.

FIG. 10 illustrates an example of RRC configuration for a CSI interference management (IM) Resource.

FIG. 11 illustrates an example of CSI reporting.

FIG. 12 illustrates an example of a UE in accordance with aspects of the present disclosure.

FIG. 13 illustrates an example of a processor in accordance with aspects of the present disclosure.

FIG. 14 illustrates an example of a network equipment (NE) in accordance with aspects of the present disclosure.

FIG. 15 illustrates a flowchart of a method performed by a UE in accordance with aspects of the present disclosure.

FIG. 16 illustrates a flowchart of a method performed by a UE in accordance with aspects of the present disclosure.

FIG. 17 illustrates a flowchart of a method performed by a NE in accordance with aspects of the present disclosure.

FIG. 18 illustrates a flowchart of a method performed by a NE in accordance with aspects of the present disclosure.

### DETAILED DESCRIPTION

In 3rd Generation Partnership Project (3GPP) new radio (NR) networks, AI/ML techniques are considered strong candidates for wireless networks. One challenge with supporting AI/ML techniques is that obtaining ubiquitous training data for the AI/ML-enabled schemes is instrumental to maintain the robustness of the AI/ML techniques against variations in the environment that would lead to drifts in realistic measurements compared with measurements within the training dataset. Accordingly, the techniques discussed herein provide a training dataset approach that enables partial update of the training dataset to enable capturing latest channel variations without naively omitting older measurements of the dataset points.

More specifically, the dataset is partitioned into multiple dataset groups. Each dataset group is associated with a distinct time stamp corresponding to an approximate time of the collection of the datapoints of the dataset group, and dataset points of a dataset group associated with a more recent time replace dataset points of a second dataset group associated with a former time. The datapoints of the dataset groups, as well as their corresponding labels, may be signaled from one communication node to another.

Each dataset group is also associated with a distinct weight corresponding to a correlation with the actual or real-time data, and the weight values may be signaled from one communication node to another. Based on these weights, one of multiple operations is pursued by the communication node possessing the ground truth (e.g., the communication node that collected the datapoints in the dataset group). These operations may include, for example, one or more of updating the value of a label of an already shared dataset partition, adding a new dataset partition with a new set of data points, or omitting information corresponding to a dataset partition with the least weight (e.g., due to memory constraints).

Based on auxiliary information, e.g., based on information obtained during an AI/ML model maintenance phase, the datapoints of the dataset can be further decomposed to multiple dataset groups based on a characteristic of the dataset points, such as based on a classifier function. The grouping of the datapoints in the dataset is based on the characteristic, which may be observable (e.g., can be directly computed from the value of the datapoint) or unobservable (e.g., inferred from analyzing the characteristics of a large group of datapoints, such as statistical characteristics).

The techniques discussed herein provide a training dataset approach that enables partial update of the training dataset to enable capturing latest channel variations without naively omitting older measurements of the dataset points. The training dataset is not fully replaced with a new dataset after a configured or fixed period of time, or based on an event. Accordingly, the techniques discussed herein avoid situations where some datapoints in a legacy dataset that may be helpful to improve the model training and may still be correlated to real-time measurements obtained in the present are replaced by the new dataset.

Furthermore, the training dataset is not updated by simply appending new datapoints to the same dataset every configured or fixed period of time, or based on an event. Accordingly, the techniques discussed herein avoid situations where the size of the dataset grows unboundedly after every iteration of adding new datapoints. Furthermore, the techniques discussed herein avoid situations where the dataset is contaminated if the newly added datapoints are associated with a same weight as that of stale datapoints that were collected in a prior time.

Aspects of the present disclosure are described in the context of a wireless communications system.

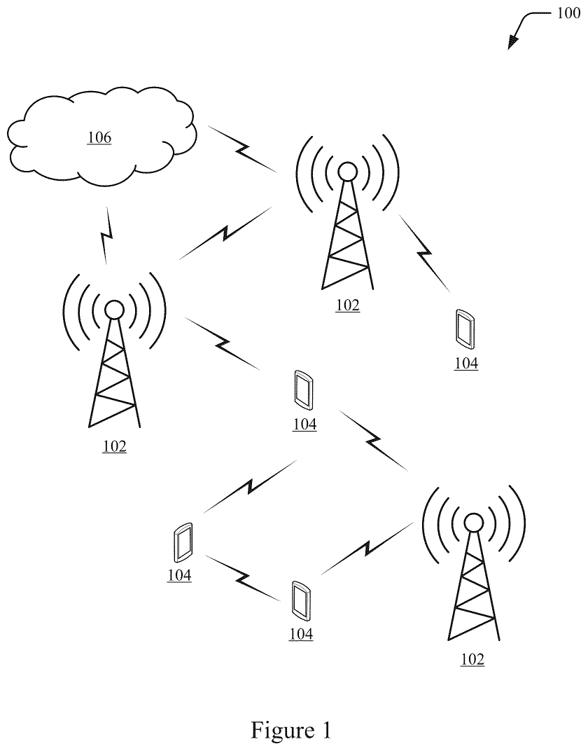

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The NEs 102 and the UEs 104 may include one or more AI/ML systems (which may also be referred to as AI/ML algorithms or AI/ML models). These AI/ML systems are initially trained on a training dataset that includes multiple training datapoints. Additional training datapoints are collected and the AI/ML systems are re-trained based at least in part on the additional datapoints.

The training dataset is partitioned into multiple dataset groups and each dataset group includes one or more training datapoints. Each dataset group is associated with a first label and a second label. The first label corresponds to a temporal or time-domain related parameter, such as a time stamp or a time duration. The second label is at least one of a weight or a value associated with a characteristic of the dataset. The training dataset is updated based on at least one of the first label or the second label, such as by updating a subset of values of the second label, removing a dataset group, or adding a new dataset group to the training dataset. Updated information corresponding to the updated training dataset can then be sent from one device to another (e.g., from NE 102 to UE 104, or from UE 104 to NE 102).

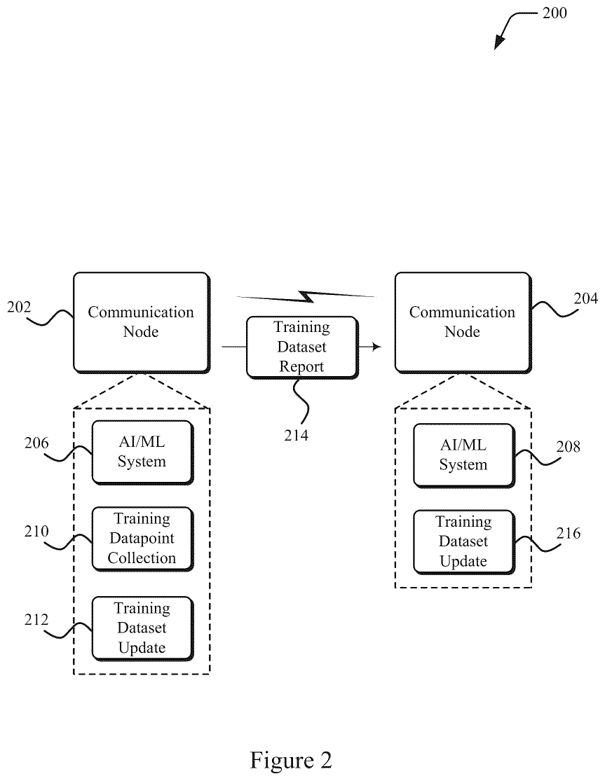

FIG. 2 illustrates an example 200 of training dataset updates in accordance with aspects of the present disclosure. The example 200 illustrates a communication node 202 and a communication node 204. In one or more implementations the communication node 202 is a NE 102 and the communication node 204 is a UE 104. In one or more implementations, the communication node 202 is a UE 104 and the communication node 204 is a NE 102. In one or more implementations, the communication node 202 and the communication node 204 are both UEs 104. In one or more implementations, the communication node 202 and the communication node 204 are both NEs 102.

The communication node 202 includes an AI/ML system 206 and the communication node 204 includes an AI/ML system 208. The communication node 202 includes a training datapoint collection process 210 that collects datapoints and a training dataset update process 212 that updates a training dataset based on the collected datapoints. The training dataset is partitioned into multiple dataset groups and each dataset group includes one or more training datapoints as discussed in more detail below. The communication node 202 transmits a training dataset report 214 to the communication node 204 that includes the updated dataset. The communication node 204 also includes a training dataset update process 216. Accordingly, the training dataset at the communication node 204 can be updated in the same manner as the training dataset at the communication node 202, allowing the AI/ML system 206 and the AI/ML system 208 to be retrained using the same updated training dataset.

The techniques discussed herein support various NR codebook types, such as the NR codebook types discussed in 3GPP technical specification (TS) 38.214, “Physical layer procedures for data,” March 2020. A summary of these techniques follows.

One codebook type is a NR Rel. 15 Type-II Codebook. Assume the NE 102 is equipped with a two-dimensional (2D) antenna array with N₁, N₂ antenna ports per polarization placed horizontally and vertically and communication occurs over N₃ precoder matrix indicator (PMI) sub-bands. A PMI subband consists of a set of resource blocks, each resource block consisting of a set of subcarriers. In such case, 2N₁N₂ CSI-RS ports are utilized to enable downlink (DL) channel estimation with high resolution for NR Rel. 15 Type-II codebook. In order to reduce the uplink (UL) feedback overhead, a Discrete Fourier transform (DFT)-based CSI compression of the spatial domain is applied to L dimensions per polarization, where L<N₁N₂. In the sequel the indices of the 2L dimensions are referred as the Spatial Domain (SD) basis indices. The amplitude and phase values of the linear combination coefficients for each sub-band are fed back to the NE 102 as part of the CSI report. The 2N₁N₂×N₃ codebook per layer l takes on the form

Wₗ=W₁W_{2,l},

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ 1 {e}^{j \frac{2 π m}{{O}_{2} {N}_{2}}} ⋯ {e}^{j \frac{2 π m ( {N}_{1} - 1 )}{{O}_{2} {N}_{2}}} ] , \\ {v}_{l , m} = {[ {u}_{m} {e}^{j \frac{2 π l}{{O}_{1} {N}_{1}}} {u}_{m} ⋯ {e}^{j \frac{2 π ( {N}_{1} - 1 )}{{O}_{1} {N}_{1}}} {u}_{m} ]}^{T} , \\ B = [ {v}_{{l}_{0} , {m}_{0}} {v}_{{l}_{1} , {m}_{1}} ⋯ {v}_{{l}_{L - 1} , {m}_{L - 1}} ] , \\ {l}_{i} = {O}_{1} {N}_{1}^{( i )} + {q}_{1} , 0 \leq {n}_{1}^{( i )} < {N}_{1} , 0 \leq {q}_{1} < {O}_{1} , \\ {m}_{i} = {O}_{2} {N}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ oversampling factors are assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,l} are independent for different layers.

One codebook type is a NR Rel. 15 Type-II Port Selection codebook. For Type-II Port Selection codebook, only K (where K≤2N₁N₂) beamformed CSI-RS ports are utilized in DL transmission, in order to reduce complexity. The. The K×N₃ codebook matrix per layer takes on the form

$${W}_{l} = {W}_{1}^{PS} {W}_{2 , l} .$$

Here, W₂ follow the same structure as the conventional NR Rel. 15 Type-II Codebook, and are layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2 )}^{( K / 2 )} ] ,$$

where eᵢ^{(K)} is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

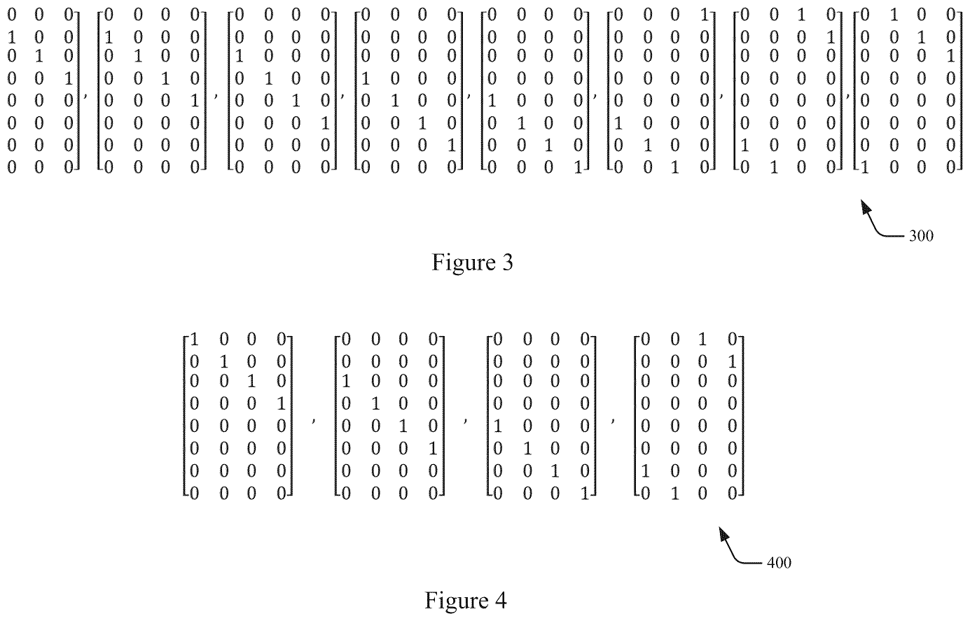

FIG. 3 illustrates an example 300 of matrices as related to channel state information reporting using mixed reference signal types. For K=16, L=4 and d_{PS}=1, the 8 possible realizations of E corresponding to m_{PS}={0, 1, . . . , 7} are illustrated in the example 300.

FIG. 4 illustrates an example 400 of matrices as related to channel state information reporting using mixed reference signal types. When d_{PS}=2, the 4 possible realizations of E corresponding to m_{PS}={0,1,2,3} are illustrated in the example 400.

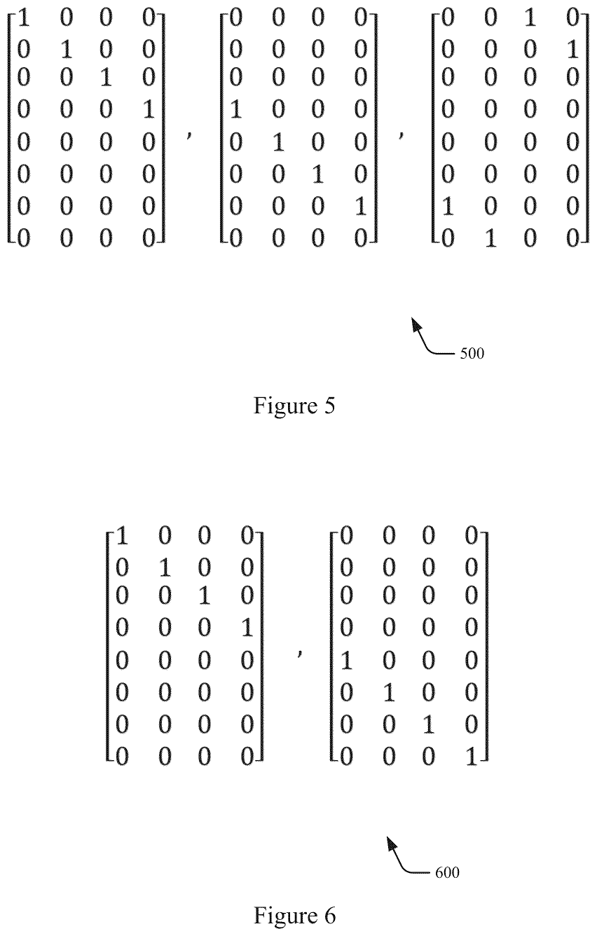

FIG. 5 illustrates an example 500 of matrices as related to channel state information reporting using mixed reference signal types. When d_{PS}=3, the 3 possible realizations of E corresponding of m_{PS}={0,1,2} are illustrated in the example 500.

FIG. 6 illustrates an example 600 of matrices as related to channel state information reporting using mixed reference signal types. When d_{PS}=4, the 2 possible realizations of E corresponding of m_{PS}={0,1} are illustrated in the example 600.

One codebook type is a NR Rel. 15 Type-I codebook. NR Rel. 15 Type-I codebook is the baseline codebook for NR, with a variety of configurations. The most common utility of Rel. 15 Type-I codebook is a special case of NR Rel. 15 Type-II codebook with L=1 for rank indicator (RI)=1,2, where a phase coupling value is reported for each sub-band, i.e., W_{2,l} is 2×N₃, with the first row equal to [1, 1, . . . , 1] and the second row equal to [e^{j2πØ}^{₀}, . . . , e^{j2πØ}^{_{N}}3-1]. Under specific configurations, ϕ₀=ϕ₁= . . . =ϕ_{N}_{₃}₋₁, i.e., wideband reporting. For RI>2 different beams are used for each pair of layers. NR Rel. 15 Type-I codebook can be depicted as a low-resolution version of NR Rel. 15 Type-II codebook with spatial beam selection per layer-pair and phase combining only.

One codebook type is a NR Rel. 16 Type-II codebook. Assume the NE 102 is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the amplitude and phase values of a subset of the delay-domain coefficients are selected and fed back to the NE 102 as part of the CSI report. The 2N₁N₂×N₃ codebook per layer takes on the form

$${W}_{l} = {W}_{1} {, l}_{} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ 1 {e}^{j \frac{2 π m}{{O}_{2} {N}_{2}}} ⋯ {e}^{j \frac{2 π m ( {N}_{1} - 1 )}{{O}_{2} {N}_{2}}} ] , \\ {v}_{l , m} = {[ {u}_{m} {e}^{j \frac{2 π l}{{O}_{1} {N}_{1}}} {u}_{m} ⋯ {e}^{j \frac{2 π ( {N}_{1} - 1 )}{{O}_{1} {N}_{1}}} {u}_{m} ]}^{T} , \\ B = [ {v}_{{l}_{0} , {m}_{0}} {v}_{{l}_{1} , {m}_{1}} ⋯ {v}_{{l}_{L - 1} , {m}_{L - 1}} ] , \\ {l}_{i} = {O}_{1} {N}_{1}^{( i )} + {q}_{1} , 0 \leq {n}_{1}^{( i )} < {N}_{1} , 0 \leq {q}_{1} < {O}_{1} , \\ {m}_{i} = {O}_{2} {N}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. Why is an N₃×M matrix (M<N₃) with columns selected from a critically-sampled size-N₃ DFT matrix, as follows

$${W}_{f , l} = [ {f}_{{k}_{0}} {f}_{{k}_{1}} ⋯ {f}_{{k}_{M - 1}} ] , 0 \leq {k}_{i} \leq {N}_{3} - 1 , \\ {f}_{k} = {[ 1 {e}^{- j \frac{2 π k}{{N}_{3}}} ⋯ {e}^{- j \frac{2 π k ( {N}_{3} - 1 )}{{N}_{3}}} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix [symbol] represents the linear combination coefficients (LCCs) of the spatial and frequency DFT-basis vectors. Both [symbol] and W_{f,l} are selected independently for different layers. Amplitude and phase values of an approximately β fraction of the 2LM available coefficients are reported to the NE 102 (β<1) as part of the CSI report. Coefficients with zero amplitude values are indicated via a layer-specific bitmap matrix Sₗ of size 2L×M, where each bit of the bitmap matrix Sₗ indicates whether a coefficient has a zero-amplitude value, where for these coefficients no quantized amplitude and phase values need to be reported. Since all non-zero coefficients reported within a layer are normalized with respect to the coefficient with the largest amplitude value (strongest coefficient), where the amplitude and phase values corresponding to the strongest coefficient are set to one and zero, respectively, and hence no further amplitude and phase information is explicitly reported for this coefficient, and only an indication of the index of the strongest coefficient per layer is reported. Hence, for a single-layer transmission, amplitude, and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

One codebook type is a NR Rel. 16 Type-II Port Selection codebook. For Type-II Port Selection codebook, only K (where K≤2N₁N₂) beamformed CSI-RS ports are utilized in DL transmission, in order to reduce complexity. The. The K×N₃ codebook matrix per layer takes on the form [1].

$${W}_{l} = {W}_{1} {, l}_{} {W}_{f , l}^{H} .$$

Here, [symbol] and W_{f,l} follow the same structure as the conventional NR Rel. 16 Type-II Codebook, where both are layer specific. The matrix WPS is a K×2L block-diagonal matrix with the same structure as that in the NR Rel. 15 Type-II Port Selection Codebook.

One codebook type is a NR Rel. 17 Type-II Port Selection Codebook. Rel. 17 Type-II Port Selection codebook follows a similar structure as that of Rel. 15 and Rel. 16 port-selection codebooks, as follows

$${W}_{l} = {\overline{W}}_{1}^{PS} {, l}_{} {W}_{f , l}^{H} .$$

However, unlike Rel. 15 and Rel. 16 Type-II port-selection codebooks, the port-selection matrix W̅₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, where this selection is common across all layers. Here, [symbol] and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

One codebook type is a NR Rel. 18 Type-II Codebook. For Rel-18 potential Type-II codebook, the time-domain corresponding to slots is further compressed via DFT-based transformation, where the codebook is in the following form

$${W}_{l} = {W}_{1} {, l}_{} {( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ {d}_{{q}_{0}} {d}_{{q}_{1}} ⋯ {d}_{{1}_{Q - 1}} ] , 0 \leq {q}_{i} \leq {N}_{4} - 1 , \\ {d}_{q} = {[ 1 {e}^{- j \frac{2 π q}{{N}_{4}}} ⋯ {e}^{- j \frac{2 π q ( {N}_{4} - 1 )}{{N}_{4}}} ]}^{T} .$$

Only the indices of the Q selected columns of W_{d,l} are reported. Note that W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, [symbol] is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with Rel-18 Type-II codebook

For codebook reporting, the codebook report is partitioned into two parts based on the priority of information reported. Each part is encoded separately (Part 1 has a possibly higher code rate). Below the parameters for NR Rel. 16 Type-II codebook are listed only.

The content of the CSI report includes Part 1 and Part 2. Part 1 includes the RI plus the channel quality indicator (CQI) plus the total number of coefficients. Part 2 includes the SD basis indicator plus the FD basis indicator/layer plus the Bitmap/layer plus the Coefficient Amplitude info/layer plus the Coefficient Phase info/layer plus the Strongest coefficient indicator/layer. Furthermore, Part 2 CSI can be decomposed into sub-parts each with different priority (higher priority information listed first). Such partitioning is used to allow dynamic reporting size for codebook based on available resources in the uplink phase. Also Type-II codebook is based on aperiodic CSI reporting, and only reported in physical uplink shared channel (PUSCH) via downlink control information (DCI) triggering (one exception). Type-I codebook can be based on periodic CSI reporting physical uplink control channel (PUCCH) or semi-persistent CSI reporting (PUSCH or PUCCH) or aperiodic reporting (PUSCH).

For Priority reporting for Part 2 CSI, note that multiple CSI reports may be transmitted with different priorities, as shown in Table 1. Table 1 shows the reporting levels for Part 2 CSI.

TABLE 1

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Additionally, the priority of the N_{Rep} CSI reports are based on the following: 1) a CSI report corresponding to one CSI reporting configuration for one cell may have higher priority compared with another CSI report corresponding to one other CSI reporting configuration for the same cell, 2) CSI reports intended to one cell may have higher priority compared with other CSI reports intended to another cell, 3) CSI reports may have higher priority based on the CSI report content, e.g., CSI reports carrying L1-RSRP information have higher priority, 4) CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower identifiers (IDs) have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

where s refers to the CSI reporting configuration index, Mₛ refers to the maximum number of CSI reporting configurations, c refers to the cell index, N_{cells} refers to the number of serving cells, k is 0 for CSI reports carrying L1-RSRP or L1-SINR, 1 otherwise, y is 0 for aperiodic reports, 1 for semi-persistent reports on PUSCH, 2 for semi-persistent reports on PUCCH, 3 for periodic reports.

With respect to triggering aperiodic CSI reporting on PUSCH, the UE reports the needed CSI information for the network using the CSI framework in NR Release 15. The triggering mechanism between a report setting and a resource setting can be summarized in Table 2 below, which refers to medium access control element (MAC CE), semi-persistent (SP), and aperiodic (AP).

TABLE 2

| | | Periodic CSI | | AP CSI |
|---|---|---|---|---|
| | | reporting | SP CSI reporting | Reporting |
| Time Domain | Periodic | RRC | MAC CE (PUCCH) | DCI |
| Behavior of | CSI-RS | configured | DCI (PUSCH) | |
| Resource | SP CSI-RS | Not | MAC CE (PUCCH) | DCI |
| Setting | | Supported | DCI (PUSCH) | |
| | AP CSI-RS | Not | Not Supported | DCI |
| | | Supported | | |

Moreover, all associated Resource Settings for a CSI Report Setting need to have same time domain behavior. Periodic CSI-RS/IM resource and CSI reports are always assumed to be present and active once configured by RRC. Aperiodic and semi-persistent CSI-RS/IM resources and CSI reports needs to be explicitly triggered or activated. Aperiodic CSI-RS/IM resources and aperiodic CSI reports, the triggering is done jointly by transmitting a DCI Format 0-1. Semi-persistent CSI-RS/IM resources and semi-persistent CSI reports are independently activated.

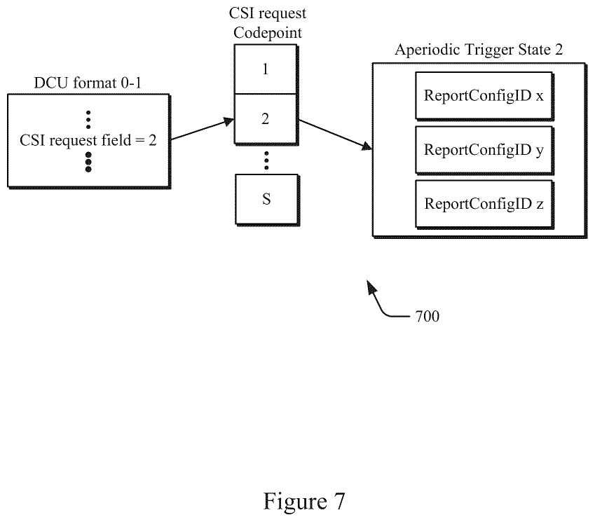

For aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC (see FIG. 7). An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

FIG. 7 illustrates an example 700 of aperiodic trigger state defining a list of CSI Report Settings.

When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition

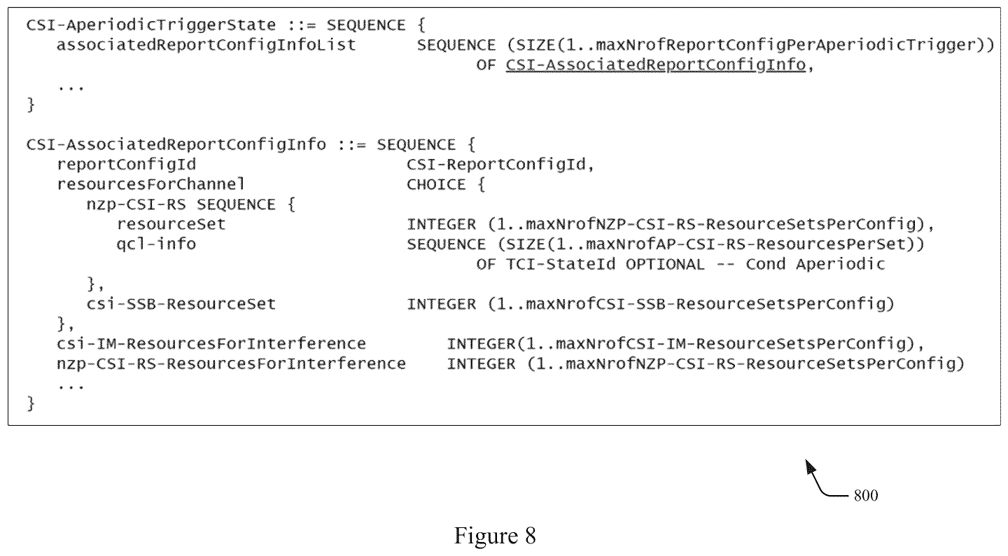

FIG. 8 illustrates an example 800 of aperiodic trigger state. The example 800 illustrates that aperiodic trigger state indicates the resource set and quasi co-location (QCL) information.

For aperiodic NZP CSI-RS, the QCL source to use is also configured in the aperiodic trigger state. The UE assumes that the resources used for the computation of the channel and interference can be processed with the same spatial filter i.e. quasi-co-located with respect to “QCL-TypeD.”

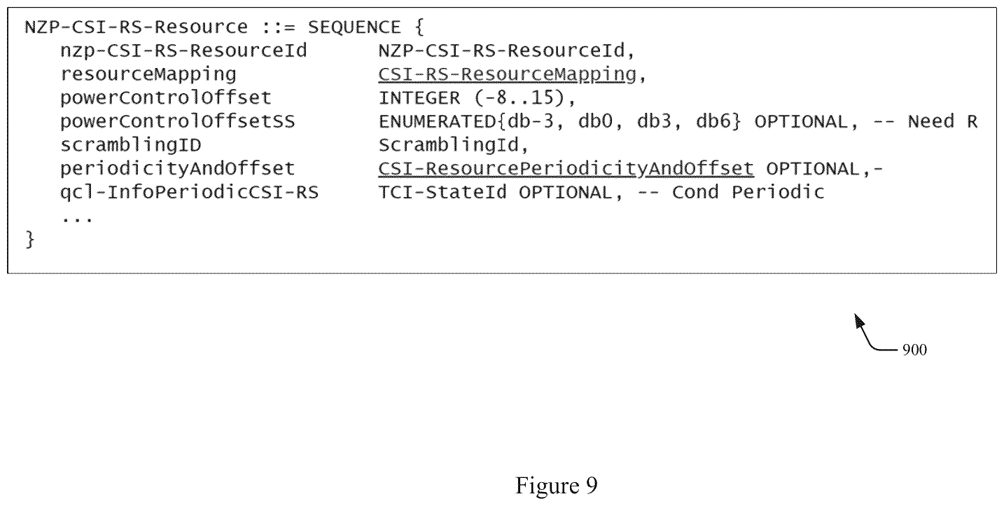

FIG. 9 illustrates an example 900 of RRC configuration for a NZP CSI-RS Resource.

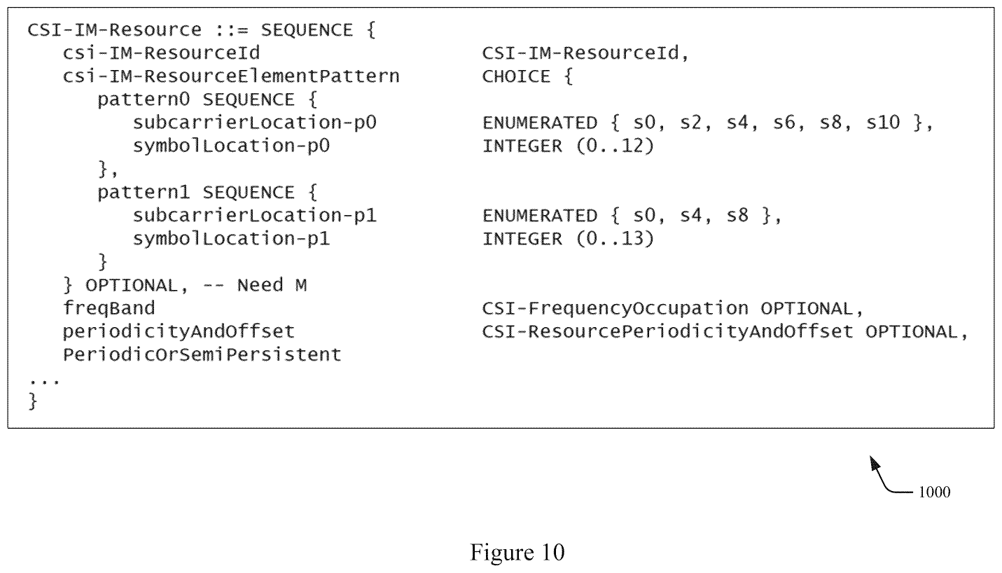

FIG. 10 illustrates an example 1000 of RRC configuration for a CSI-IM-Resource.

Table 3 summarizes the type of uplink channels used for CSI reporting as a function of the CSI codebook type, and refers to subband (SB) and wideband (WB).

TABLE 3

| | Periodic CSI | | AP CSI |
|---|---|---|---|
| | reporting | SP CSI reporting | reporting |
| Type I WB | PUCCH Format 2, 3, 4 | PUCCH Format 2 | PUSCH |
| | | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports are divided into two CSI parts: CSI Part1 and CSI Part 2. The reason for this is that the size of CSI payload varies significantly, and therefore a worst-case uplink control information (UCI) payload size design would result in large overhead.

CSI Part 1 has a fixed payload size (and can be decoded by the NE 102 without prior information) and contains the following: RI (if reported), CSI-RS resource index (CRI) (if reported) and CQI for the first codeword; number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4.

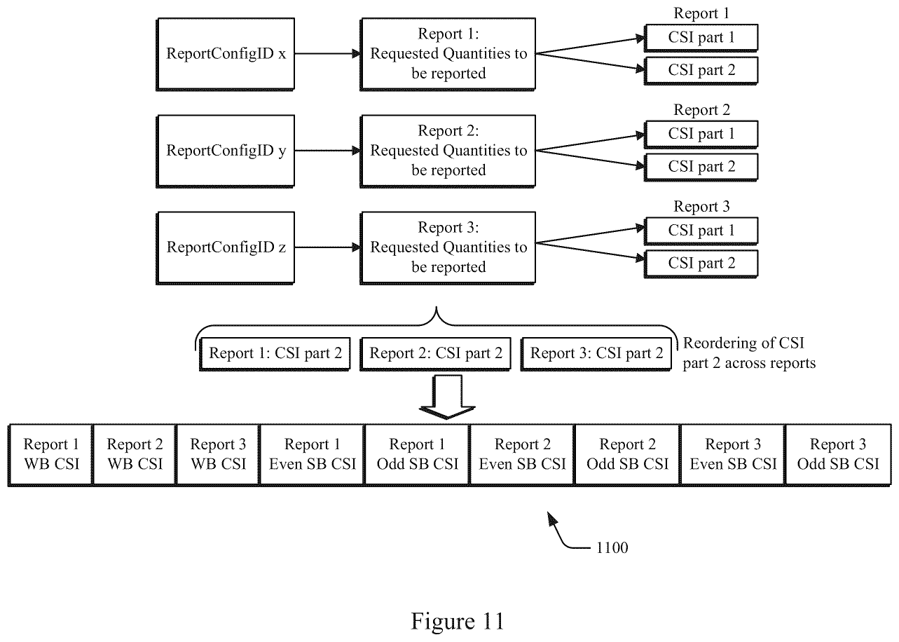

FIG. 11 illustrates an example 1100 of CSI reporting. The example 1100 illustrates the ordering of the aperiodic CSI reporting for CSI part 2 if the aperiodic trigger state indicated by DCI format 0_1 defines 3 report settings x, y, and z. The example 1100 is a partial CSI omission for Rel. 15 PUSCH-Based CSI.

As mentioned earlier, CSI reports are prioritized according to: 1) time-domain behavior and physical channel, where more dynamic reports are given precedence over less dynamic reports and PUSCH has precedence over PUCCH; 2) CSI content, where beam reports (i.e., L1-RSRP reporting) has priority over regular CSI reports; 3) the serving cell to which the CSI corresponds (in case of carrier aggregation (CA) operation), CSI corresponding to the PCell has priority over CSI corresponding to Scells; 4) the reportConfigID.

With respect to CQI reporting, a CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from QPSK up to 1024QAM, whereas the code rate may vary from 30/1024 up to 948/1024. Table 4 describes one example of a CQI table for a 4-bit CQI indicator that identifies a possible CQI value with the corresponding modulation order, code rate and efficiency.

TABLE 4

| CQI | | code rate × | |
|---|---|---|---|
| index | modulation | 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

A CQI value may be reported in two formats: a wideband format, where one CQI value is reported corresponding to each physical downlink shared channel (PDSCH) transport block, and a subband format, where one wideband CQI value is reported for the entire transport block, in addition to a set of subband CQI values corresponding to CQI subbands on which the transport block is transmitted. CQI subband sizes are configurable, and depends on the number of PRBs in a bandwidth part. Table 5 shows an example of Configurable subband sizes for a given bandwidth part (BWP) size.

TABLE 5

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, i.e., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

Sub-band Offset level(s)=sub-band CQI index(s)−wideband CQI index.

Table 6 shows the mapping from the 2-bit sub-band differential CQI values to the offset level.

TABLE 6

| Sub-band differential CQI value | Offset level |
|---|---|
| 0 | 0 |
| 1 | 1 |
| 2 | ≥2 |
| 3 | ≤−1 |

With respect to the AI/ML model for CSI measurement and reporting, for AI/ML-based CSI frameworks multiple alternatives exist for the outline of the AI/ML algorithm functionality, as follows.

In one or more implementations, the AI/ML model is trained at the UE. This alternative may appear reasonable since the UE is the node that can seamlessly collect training data for CSI acquisition using DL pilot signals, e.g., CSI-RSs for channel measurement, however, the AI/ML model is typically re-trained whenever the environment changes, e.g., change of the UE location or orientation and every training instance involves significant memory and computational complexity requirements.

In one or more implementations, the AI/ML model is trained at the network node (e.g., NE 102). One advantage of this approach is that the network has significantly more power and computational capabilities compared with a UE, and hence can manage training moderately complex AI/ML models, as well as store large amounts of training data. Moreover, since a network node is mostly assumed to be fixed, its coverage area is expected to be the same and hence a single AI/ML model can be applicable to UEs within a specific region of the cell for a reasonable period of time. The one challenge with this approach is related to obtaining the training data at the network node, especially for frequency-division duplexing (FDD) systems in which the UL/DL channel reciprocity may not hold. Note that the overhead corresponding to feeding back the training data from the UE to the network should be considered as one of the metrics when assessing the efficiency of an AI/ML algorithm.

In the sequel, we assume the AI/ML model is trained at the network due to the advantages corresponding to memory, computation, and cell-centric characteristics of the network-based AI/ML model computation. The challenge corresponding to obtaining the training data corresponding to the DL channel at the network side is discussed below.

With respect to obtaining the training data, assuming the AI/ML model is trained at the network, a few aspects of DL training data acquisition at the network side to enable efficient AI/ML modeling are as follows.

In order to maintain the robustness of the AI/ML model with respect to channel variations, DL training data is typically continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations is typically characterized.

Based on the current codebook-based DL CSI feedback schemes in NR, the CSI is compressed in at least one of the spatial domain or the frequency domain. One intuitive approach would be using the codebook-based CSI feedback, e.g., Type-I and/or Type-II codebooks for obtaining the training data. One disadvantage of this approach is that the training data would comprise CSI feedback that is already compressed via conventional approaches, which would have detrimental effect on the AI/ML model inference accuracy. For instance, if the AI/ML model compares the output of the AI/ML model with the channel corresponding to the CSI feedback to assess its own inference accuracy, this assessment would not be precise since it is based on H′, an estimate of the channel based on a pre-defined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/ML model, which is mainly to reduce the overall CSI feedback overhead. Numerically, an AI/ML-based CSI feedback aims at minimizing the following metric

$${min}_{\hat{H}} ‖ \hat{H} - H ‖$$

where H refers to a digital-domain representation of the channel matrix. On the other hand, a compressed channel H′, which represents the recovered channel after codebook-based transformation, would yield the following optimization metric

$${min}_{\hat{H}} ‖ \hat{H} - {H}^{′} ‖$$

Since H≠H′, the output of both optimizations would yield different channel estimates.

With respect to output of the AI/ML model, for DL CSI acquisition in NR, whether the network operates in FDD mode or time-division duplexing (TDD) mode, it is unlikely that AI/ML would fully replace RS-based CSI feedback for high-resolution precoding design, since some channel parameters may vary from one time instant to another, without strong correlation across the two time instants, e.g., initial random phases of the channel. Given that, AI/ML-based CSI framework can be envisioned as means of further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, where a different transformation may be selected for a given UE based on variations of the channel.

The following includes additional information regarding antenna panel/port, quasi-collocation, transmission configuration indication (TCI) state, and spatial relation.

In one or more implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHZ, e.g., frequency range 2 (FR2) or millimeter wave (mmWave). In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

Additionally or alternatively, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

Additionally or alternatively, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

Additionally or alternatively, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to the NE 102. For certain condition(s), the NE 102 or network can assume the mapping between device's physical antennas to the logical entity “device panel” may not be changed. For example, the condition may include until the next update or report from device or comprise a duration of time over which the NE 102 assumes there will be no change to the mapping. A device may report its capability with respect to the “device panel” to the NE 102 or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

Additionally or alternatively, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, or spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receiver (RX) beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In one or more implementations, a TCI-state (Transmission Configuration Indication) associated with a target transmission can indicate parameters for configuring a quasi-collocation relationship between the target transmission (e.g., target RS of DM-RS ports of the target transmission during a transmission occasion) and one or more source reference signals (e.g., synchronization signal block (SSB)/CSI-RS/sounding reference signal (SRS)) with respect to one or more quasi co-location type parameters indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source RS to provide a reference (UE assumption) for determining QCL and/or spatial filter.

Additionally or alternatively, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

Additionally or alternatively, a UL TCI state is provided if a device is configured with separate DL/UL TCI by RRC signaling. The UL TCI state may comprises a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

Additionally or alternatively, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Assume a channel between a UE 104 and an NE 102 (e.g., gNB) with P channel paths (index μ=0, . . . , P−1) that occupies N_{SB} frequency bands (index n=0, . . . , N_{SB}−1), where the gNB is equipped with K antennas (index k=0, . . . , K−1). The channel at a time index δ can then be represented as follows

$${h}_{k , n} ( δ ) = {\sum }_{p = 0}^{P - 1} {q}_{k , p} {e}^{j 2 π n Δ f {τ}_{p} + j 2 π k \frac{{F}_{c} d}{c} sin {θ}_{p} + j 2 πδ \frac{{F}_{c} v}{c} cos {∅}_{p}}$$

where g_{k,p} refers to complex gain of path p at antenna k, Δf refers to PMI Sub-band spacing, τₚ: refers to delay of path p, F_{c} refers to carrier frequency, c refers to speed of light, d refers to antenna spacing at NE 102 (e.g., gNB), θₚ refers to angular spatial displacement at the NE 102 (e.g., gNB) antenna array corresponding to path p, δ refers to time index, v refers to relative speed between NE 102 (e.g., gNB) & UE, and Φₚ refers to angle between the moving direction & the signal incidence direction of path p.

The channel above is parametrized by three dimensions: spatial, frequency and time dimensions. In order to construct a precoder codebook with reasonable CSI feedback overhead, the CSI corresponding to the three dimensions is compressed. In Rel. 16 eType-II codebook, both spatial and frequency domains are compressed via DFT transformation of the spatial and frequency domains with columns of two-dimensional and one-dimensional DFT matrices, respectively, whereas in potential Rel-18 eType-II codebook for high speed, the time domain is further compressed via DFT transformation in the form of columns of a one-dimensional DFT matrix. Additionally or alternatively, CSI feedback may be transmitted in an explicit format, e.g., in terms of explicit channel coefficients, so as to enhance the CSI feedback resolution. However, the CSI feedback overhead would increase significantly, especially for scenarios of training dataset transmission, in which the CSI feedback comprises a large number of training dataset points corresponding to different realizations of the CSI. In this disclosure, we propose an AI-based CSI framework in which statistical CSI training data is reported via aggregating similar training dataset points corresponding to CSI, where a corresponding weight or rate of occurrence of this dataset point is fed back as part of the CSI feedback corresponding to the training data. Moreover, likelihood ratios of whether a given coefficient corresponding to a channel or precoding matrix is associated with a non-zero amplitude value are reported, where the likelihood ratios are based on the weight or rate of occurrence of a given CSI datapoint as part of the training dataset point. Furthermore, the aforementioned AI-based CSI framework helps infer the characteristics of the channel distribution based on the training dataset, such that CSI feedback can utilize distribution-aware data compression schemes, e.g., Huffman coding, where CSI parameters are encoded such that values with higher likelihood of occurrence are mapped to a shorter sequence of bits, whereas CSI parameters are encoded such that values with lower likelihood of occurrence are mapped to a longer sequence of bits.

The “training dataset” may also be referred to as simply the “dataset” in this disclosure.

With respect to an indication of CSI training dataset transmission, in one or more implementations the training dataset is transmitted from a network node to the UE. In one example, the training dataset is transmitted over a PDSCH. In another example, the training dataset is transmitted over a PDCCH. In another example, the training dataset is transmitted via higher-layer signaling, e.g., as part of an RRC configuration.

In one or more implementations, the training dataset is transmitted from the UE to a network node (e.g., NE 102). In one example, the training dataset is transmitted over a PUSCH. In another example, the training dataset is transmitted over a PUCCH. In another example, the training dataset is further divided into two parts, a first part of the two parts of the training dataset is transmitted over the PUCCH, and a second part of the two parts of the training dataset is transmitted over the PUSCH.

In one or more implementations, the training dataset corresponds to a report type that is configured via a reporting setting. In one example, the reporting setting comprises a higher-layer configuration parameter, where the higher-layer configuration parameter is set to true if the dataset report corresponds to a training dataset report. The higher-layer configuration parameter is, for example, part of an RRC configuration.

In one or more implementations, the training dataset is configured via a dedicated higher-layer configuration, e.g., training data setting or AI/ML setting.

With respect to grouping of dataset points, in one or more implementations, the dataset including the dataset points is partitioned into one or more dataset groups. In one example, all dataset points of the dataset are mapped to a same group, i.e., the dataset group is equivalent to the dataset. In another example, each dataset point is mapped to a distinct group, i.e., each dataset point is exclusively mapped to a dataset group. In another example, the dataset point is partitioned to two or more dataset groups, where each dataset group comprises a plurality of dataset points.

In one or more implementations, a number of dataset groups in the dataset is bounded by a maximum number of dataset groups. In one example, a dataset including a number of dataset groups equal to the maximum number of dataset groups cannot include an additional dataset group without removing a dataset group from the dataset groups in the dataset. In another example, each dataset group is associated with a set of labels, features, identification (ID) values, or a combination thereof.

In one or more implementations, a number of dataset points in the dataset group is bounded by a maximum number of dataset points. In one example, all dataset groups comprise a same number of dataset points. In another example, different dataset groups of the dataset are configured with different values of the maximum number of dataset points. In another example, each dataset point is mapped to a distinct group, i.e., each dataset point is exclusively mapped to a dataset group.

In one or more implementations, an indication of a total number of bits corresponding to a size of the training dataset is reported in a first part of a training dataset reporting, where the training dataset reporting comprises multiple parts, segments, partitions, or a combination thereof.

In one or more implementations, an identifier or indicator of a dataset group is signaled from a first communication node to a second communication node. In one example, the first communication node is a UE 104, and the second communication node is a network node (e.g., a NE 102). In another example, the first communication node is a network node (e.g., a NE 102), and the second communication node is a UE 104. In another example, the identifier or indicator corresponds to a dataset group from a set of configured dataset groups, where each dataset group of the set of configured dataset group is associated with an ID.

With respect to time labeling of dataset points, in one or more implementations, each dataset group is labeled with a time stamp. In one example, the time stamp identifies a time at which the dataset points of the dataset group are collected. In another example, the time stamp identifies a time at which the dataset points of the dataset group are added to the dataset. In another example, the time stamp identifies a time at which the dataset points of the dataset group are set to be omitted from the dataset.

In one or more implementations, each dataset group is labeled with at least one of a start time, a time interval and a time periodicity. In one example, the start time corresponds to a time at which the dataset group is activated. In another example, the time interval corresponds to an interval of time at which the dataset group is active, starting from the start time. In another example, the time periodicity corresponds to a periodic interval at which the start time and the time interval are repeated. In another example, for a start time of 4 seconds, time interval of 2 seconds and time periodicity of 10 seconds, the dataset group is activated in the following periods [4,6], [14,16], [24,26], . . . .

In one or more implementations, each dataset group is labeled with a parameter corresponding to at least one of time or delay. In one example, the labeling of the dataset is based on an output of an AI/ML algorithm. In another example, the labeling of the dataset is based on an output of a classifier function.

In one or more implementations, a value of the label corresponding to a dataset group is signaled from a first communication node to a second communication node. In one example, the first communication node is a UE 104, and the second communication node is a network node (e.g., NE 102). In another example, the first communication node is a network node (e.g., NE 102), and the second communication node is a UE 104. In another example, the value of the label is drawn from a codebook of values that are known to both communication nodes.

With respect to weight association of dataset groups, in one or more implementations each dataset group is associated with at least one of a weight, probability of occurrence, scaling factor, or priority index. In one example, dataset points of a first dataset group associated with at least one of a larger value of the weight, the probability of occurrence, the scaling factor, or the priority index correspond to a larger significance of the dataset points of the first dataset group, compared with dataset points of a second dataset group associated with at least one of a smaller value of the weight, the probability of occurrence, the scaling factor, or the priority index. In another example, at least one of a sum of the weights, the probabilities of occurrence, the scaling factors, or the priority indices across all dataset groups is equal to a unit value. In another example, at least one of the weights, the scaling factors, or the priority indices are normalized by the size of the dataset. In another example, at least one of the weights, the scaling factors, or the priority indices, are normalized by a value of the largest weight, e.g., at least one weight is set to one. In another example, a value corresponding to at least one of the weight, probability of occurrence, scaling factor, or priority index is selected from a pre-defined or pre-configured codebook of values.

In one or more implementations, at least one of the weight, the probability of occurrence, the scaling factor, the priority index, or the combination thereof of each of associated with a dataset group is updated based on an event. In one example, the event is one of periodic or semipersistent event, based on a configuration for updating the dataset, where the dataset is partially updated. In another example, the event is triggered by at least one of a network configuration signal, a downlink control information, or a MAC-CE signal. In another example, the event is triggered by at least one of a UE-based signal over an uplink control information, or multiplexed with a CSI report.

In one or more implementations, a set of dataset groups constituting the dataset are updated after each event, where a dataset group associated with at least one of a smaller value of the weight, the probability of occurrence, the scaling factor, or the priority index is replaced with a dataset group associated with at least one of a larger value of the weight, the probability of occurrence, the scaling factor, or the priority index.

In one or more implementations, dataset points corresponding to different dataset groups are ordered based on a characteristic of a corresponding dataset group. In one example, the characteristic is based on at least one of the weight, the probability of occurrence, the scaling factor, or the priority index of the dataset group. In another example, the characteristic is based on a time label or time stamp associated with the dataset group. In another example, the ordering of the dataset groups is based on an ascending order of a value associated with the characteristic. In another example, the ordering of the dataset groups is based on a descending order of a value associated with the characteristic.

In one or more implementations, a processing of a dataset group is based on one decision of a set of decisions, including updating a weight or a value of a label associated with a dataset group, no update of a weight or a value of the label associated with the dataset group, omitting dataset points associated with a dataset group associated with a small value of a weight or a low probability of occurrence, or adding a new dataset group associated with a plurality of dataset points, where the dataset group is associated with a positive value of a weight or a probability of occurrence.

With respect to classification of dataset groups, in one or more implementations a dataset point is associated with one dataset group of a plurality of dataset groups, where the grouping is based on one or more characteristics of the dataset point. In one example, a dataset point is classified to no more than one dataset group. In another example, the classification of the dataset points is based on a maintenance, closed-loop operation, e.g., AI/ML-based model maintenance. In another example, the classification of the dataset points is based on ground-truth information associated as labels of the dataset points.

In one or more implementations, the dataset points of the dataset are classified based on an observable characteristic, e.g., a characteristic that can be directly computed from the value of the datapoint. In one example, the observable characteristic is derived from a deterministic formula of the value of the dataset point. In another example, the observable characteristic is a transformed variant of the value of the dataset point based on a transformation operation, e.g., projection to a k-dimensional plane. In another example, the observable characteristic is based on a normalization of the value of the dataset point with respect to one or more values of other dataset points.

In one or more implementations, the dataset points of the dataset are classified based on an unobservable characteristic, e.g., inferred from analyzing the characteristics of a large group of datapoints, such as statistical characteristics. In one example, the unobservable characteristic corresponds to whether a dataset point is classified as an outlier or a common point. In another example, the unobservable characteristic corresponds to a statistical function, e.g., second order coherence or correlation function. In another example, the unobservable characteristic is based on a power-delay profile corresponding to an approximate distribution associated with the dataset.

With respect to dataset grouping, in one or more implementations the dataset corresponds to at least one of CSI data, or spatial, time, frequency domain precoding data, spatial beam-based data. In the following examples, “CSI” is used to refer to precoding and beam processing. In one example, a dataset group of the dataset is associated with a time stamp corresponding to at least one of a time of collection of the CSI, a time of signaling the data corresponding to the CSI, or a time interval at which the dataset point is valid. In another example, a dataset group of the dataset is associated with a value corresponding to at least one of a weight, or probability of occurrence, where a larger value corresponds to a stronger correlation of dataset points of the dataset group with the actual or reported CSI, and a smaller value corresponds to a weaker correlation of dataset points of the dataset group with the actual or reported CSI. In another example, the dataset group is classified based on an observable characteristic of the CSI, e.g., at least one of a number of dominant basis indices of a transformed frequency domain basis, i.e., channel taps, a ratio of a maximum value of a singular value to the minimum value of the singular value of the channel matrix or precoding matrix, or a power-delay profile associated with the CSI. In another example, the dataset group is classified based on an unobservable characteristic of the CSI, where the unobservable characteristic is based on an observable characteristic e.g., a flag on whether the channel corresponds to a line-of-sight (LoS) or non-line-of-sight (NLoS) channel based on a number of dominant basis indices of a transformed frequency-domain basis.

In one or more implementations, the dataset corresponds to positioning or localization data. In one example, a dataset group of the dataset is associated with at least one of a time stamp corresponding to a time of collection of the localization information, a time of signaling the data corresponding to the location, or a time interval at which the dataset point is valid. In another example, a dataset group of the dataset is associated with at least one of a value corresponding to a weight, or a probability of occurrence, where a larger value corresponds to a stronger correlation of dataset points of the dataset group with the actual location, and a smaller value corresponds to a weaker correlation of dataset points of the dataset group with the actual location. In another example, the dataset group is classified based on an observable characteristic of the position, e.g., at least one of angle of arrival, angle of departure, round-trip time, or time-difference of arrival. In another example, the dataset group is classified based on an unobservable characteristic of the location, where the unobservable characteristic is based on an observable characteristic such as a flag on whether the channel corresponds to an indoor or outdoor UE based on one or more of the values of the angle of arrival, the angle of departure, the round-trip time, or the time-difference of arrival.

In one or more implementations, the dataset corresponds to UE mobility. In one example, a dataset group of the dataset is associated with a time stamp corresponding to at least one of a time of collection of the mobility or cell association information, a time of signaling the data corresponding to the cell association, or a time interval at which the dataset point is valid. In another example, a dataset group of the dataset is associated with at least one of a value corresponding to a weight, or probability of occurrence, where a larger value corresponds to a stronger correlation of dataset points of the dataset group with a heuristic cell association or selection, and a smaller value corresponds to a weaker correlation of dataset points of the dataset group with the heuristic cell association or selection. In another example, the dataset group is classified based on an observable characteristic of the UE mobility, e.g., at least one of RSRP, SINR, beam-based information, or CSI. In another example, the dataset group is classified based on an unobservable characteristic of the mobility, where the unobservable characteristic is based on an observable characteristic such as a flag on whether the UE is associated with a best cell based on at least one of the values of the RSRP, SINR, beam-based information, or CSI.

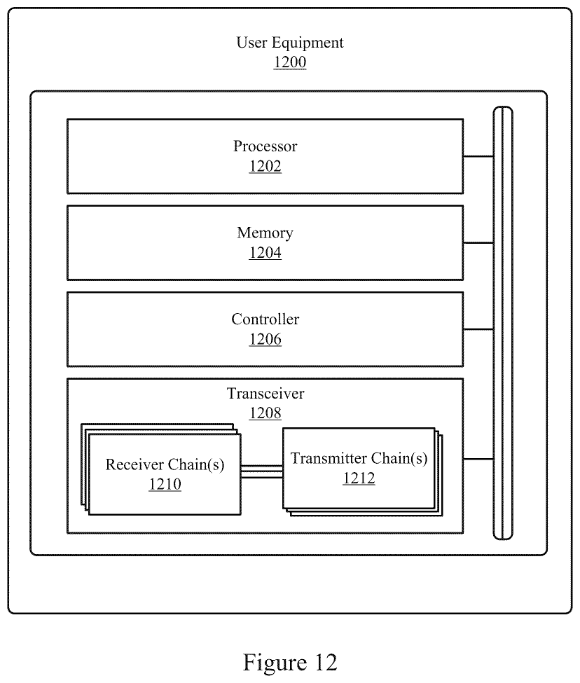

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to support a means for transmitting, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; updating the second label after transmission of the first signaling; updating the training dataset, based on at least one of the first label or the second label, by at least one of updating a subset of values of the second label of the multiple dataset groups, removing a dataset group of the multiple dataset groups, or adding a new dataset group to the dataset; and transmitting, to the network equipment over the physical channel, a second signaling indicating a second training dataset report that includes updated information corresponding to the updated training dataset.

Additionally or alternatively, the UE 1200 may be configured to support where the physical channel is an uplink channel; where a number of the multiple dataset groups is bounded by a maximum value of a number of dataset groups; where the temporal or time-domain related parameter is at least one of a time stamp or a time duration; where at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event and the event is: based on a configuration for updating the dataset, one of a periodic or a semipersistent event; triggered by at least one of a network configuration signal, a downlink control information, or a MAC-CE signal; or a combination thereof; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The UE 1200 may be configured to support a means for receiving, from a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receiving, from the network equipment over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Additionally or alternatively, the UE 1200 may be configured to support where the physical channel is a downlink channel; where a number of the multiple dataset groups is bounded by a maximum value of a number of dataset groups; where the temporal or time-domain related parameter is at least one of a time stamp or a time duration; where at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event; where the event is, based on a configuration for updating the dataset, one of a periodic or a semipersistent event; where the event is triggered by at least one of a UE-based signal over an uplink control information or multiplexed with a CSI report; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The UE 1200 may be configured to support at least one memory; and at least one processor coupled with the at least one memory and configured to cause the UE to: transmit, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; update the second label after transmission of the first signaling; update the training dataset, based on at least one of the first label or the second label, by at least one of updating a subset of values of the second label of the multiple dataset groups, removing a dataset group of the multiple dataset groups, or adding a new dataset group to the dataset; and transmit, to the network equipment over the physical channel, a second signaling indicating a second training dataset report that includes updated information corresponding to the updated training dataset.

Additionally or alternatively, the UE 1200 may be configured to support where the physical channel is an uplink channel; where a number of the multiple dataset groups is bounded by a maximum value of a number of dataset groups; where the temporal or time-domain related parameter is at least one of a time stamp or a time duration; where at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event and the event is: based on a configuration for updating the dataset, one of a periodic or a semipersistent event; triggered by at least one of a network configuration signal, a downlink control information, or a MAC-CE signal; or a combination thereof; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via is at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The UE 1200 may be configured to support at least one memory; and at least one processor coupled with the at least one memory and configured to cause the UE to: receive, from a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receive, from the network equipment over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Additionally or alternatively, the UE 1200 may be configured to support where the physical channel is a downlink channel; where a number of the multiple dataset groups is bounded by a maximum value of a number of dataset groups; where the temporal or time-domain related parameter is at least one of a time stamp or a time duration; where at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event; where the event is, based on a configuration for updating the dataset, one of a periodic or a semipersistent event; where the event is triggered by at least one of a UE-based signal over an uplink control information or multiplexed with a CSI report; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

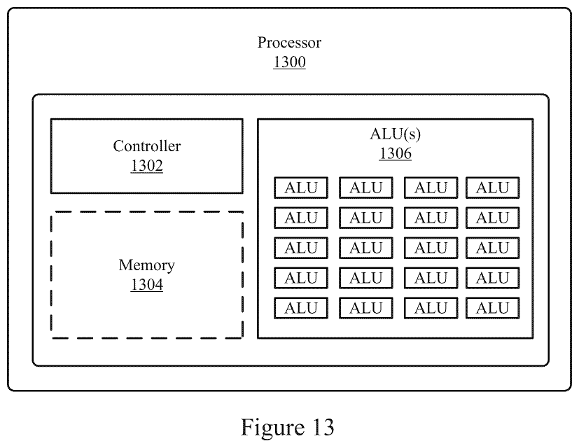

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may include at least one controller coupled with at least one memory, and may be configured to or operable to cause the processor to: transmit, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; update the second label after transmission of the first signaling; update the training dataset, based on at least one of the first label or the second label, by at least one of updating a subset of values of the second label of the multiple dataset groups, removing a dataset group of the multiple dataset groups, or adding a new dataset group to the dataset; and transmit, to the network equipment over the physical channel, a second signaling indicating a second training dataset report that includes updated information corresponding to the updated training dataset.

Additionally or alternatively, the processor 1300 may be configured to support where the physical channel is an uplink channel; where a number of the multiple dataset groups is bounded by a maximum value of a number of dataset groups; where the temporal or time-domain related parameter is at least one of a time stamp or a time duration; where at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event and the event is: based on a configuration for updating the dataset, one of a periodic or a semipersistent event; triggered by at least one of a network configuration signal, a downlink control information, or a MAC-CE signal; or a combination thereof; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the processor is associated with a best cell based on one or more of values of the RSRP, values of the SINR, beam-based information, or CSI.

The processor 1300 may include at least one controller coupled with at least one memory, and may be configured to or operable to cause the processor to: receive, from a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receive, from the network equipment over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Additionally or alternatively, the processor 1300 may be configured to support where the physical channel is a downlink channel; where a number of the multiple dataset groups is bounded by a maximum value of a number of dataset groups; where the temporal or time-domain related parameter is at least one of a time stamp or a time duration; where the at least one of the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event; where the event is, based on a configuration for updating the dataset, one of a periodic or a semipersistent event; where the event is triggered by at least one of a UE-based signal over an uplink control information or multiplexed with a CSI report; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the processor is associated with a best cell based on one or more of values of the RSRP, values of the SINR, beam-based information, or CSI.

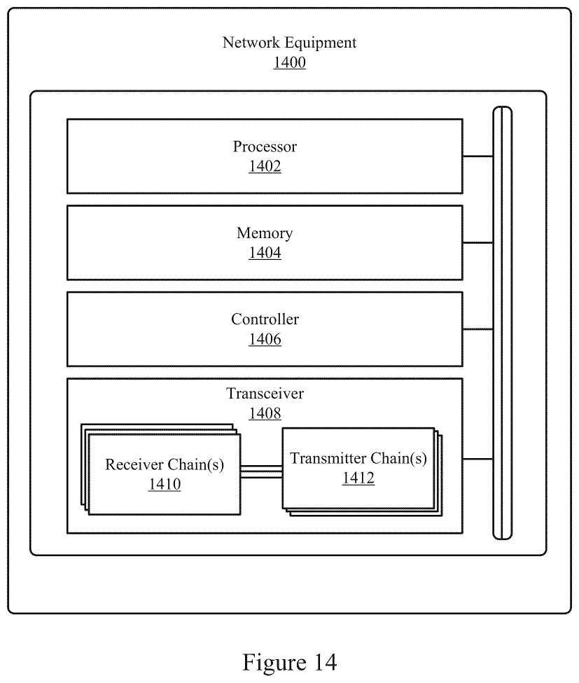

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for transmitting, to a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; updating the second label after transmission of the first signaling; updating the training dataset, based on at least one of the first label or the second label, by at least one of updating a subset of values of the second label of the multiple dataset groups, removing a dataset group of the multiple dataset groups, or adding a new dataset group to the dataset; and transmitting, to the UE over the physical channel, a second signaling indicating a second training dataset report that includes updated information corresponding to the updated training dataset.

Additionally or alternatively, the NE 1400 may be configured to support where the physical channel is an downlink channel; where a number of the multiple dataset groups is bounded by a maximum value of a number of dataset groups; where the temporal or time-domain related parameter is at least one of a time stamp or a time duration; where the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event; where the event is, based on a configuration for updating the dataset, one of a periodic or a semipersistent event; where the event is triggered by at least one of a UE-based signal over an uplink control information or multiplexed with a CSI report; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The NE 1400 may be configured to support a means for receiving, from a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receiving, from the UE over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Additionally or alternatively, the NE 1400 may be configured to support where the physical channel is an uplink channel; where a number of the multiple dataset groups is bounded by a maximum value of a number of dataset groups; where the temporal or time-domain related parameter is at least one of a time stamp or a time duration; where the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event and the event is: based on a configuration for updating the dataset, one of a periodic or a semipersistent event; triggered by at least one of a network configuration signal, a downlink control information, or a MAC-CE signal; or a combination thereof; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The NE 1400 may be configured to support at least one memory; and at least one processor coupled with the at least one memory and configured to cause the base station to: transmit, to a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; update the second label after transmission of the first signaling; update the training dataset, based on at least one of the first label or the second label, by at least one of updating a subset of values of the second label of the multiple dataset groups, removing a dataset group of the multiple dataset groups, or adding a new dataset group to the dataset; and transmit, to the UE over the physical channel, a second signaling indicating a second training dataset report that includes updated information corresponding to the updated training dataset.

Additionally or alternatively, the NE 1400 may be configured to support where the physical channel is an downlink channel; where a number of the multiple dataset groups is bounded by a maximum value of a number of dataset groups; where the temporal or time-domain related parameter is at least one of a time stamp or a time duration; where the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event; where the event is, based on a configuration for updating the dataset, one of a periodic or a semipersistent event; where the event is triggered by at least one of a UE-based signal over an uplink control information or multiplexed with a CSI report; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The NE 1400 may be configured to support at least one memory; and at least one processor coupled with the at least one memory and configured to cause the base station to: receive, from a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset; and receive, from the UE over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset.

Additionally or alternatively, the NE 1400 may be configured to support where the physical channel is an uplink channel; where a number of the multiple dataset groups is bounded by a maximum value of a number of dataset groups; where the temporal or time-domain related parameter is at least one of a time stamp or a time duration; where the first label is one of a time duration that comprises parameters corresponding to at least one of a start time, or a time interval and a time periodicity, or a time stamp that corresponds to one of a time of transmission of the datapoints of a dataset group, or a time of collection of the datapoints of the dataset group, or a combination thereof; where the weight of the dataset group is selected from a codebook of values associated with the weight; where the weight of the dataset group is updated based on an event and the event is: based on a configuration for updating the dataset, one of a periodic or a semipersistent event; triggered by at least one of a network configuration signal, a downlink control information, or a MAC-CE signal; or a combination thereof; where the training dataset is updated by replacing a dataset group associated with a smaller value of weight with a dataset group associated with a larger value of the weight; where a dataset group associated with a time stamp corresponding to a former value is replaced with a dataset group associated with a time stamp corresponding to a more recent value; where a dataset point is associated, based on one or more characteristics of the dataset point, with a dataset group of the multiple dataset groups; where the dataset point is associated with the dataset group of the multiple dataset groups based on an AI-based model maintenance process; where a characteristic in the one or more characteristics of the dataset point is an observable characteristic that is derived via at least one of: a deterministic formula of a value of the dataset point; a transformed variant of the value of the dataset point based on a transformation operation; or a normalization of the value of the dataset point with respect to one or more values of other dataset points; where the characteristic in the one or more characteristics of the dataset point is an unobservable characteristic that corresponds to at least one of: a parameter that identifies whether the dataset point is classified as an outlier or a common point; a statistical correlation parameter corresponding to an approximate distribution associated with the dataset; or a parameter corresponding to a power-delay profile corresponding to an approximate distribution associated with the dataset; where the training dataset corresponds to at least one of CSI, precoding information, or beam-based information, and where a first dataset group of the multiple data set groups is at least one of: associated with one or more of a time stamp corresponding to a time of collection of the CSI, a time of signaling data corresponding to the CSI, a time interval at which the first dataset group is valid, or a value corresponding to one or more of a weight or a probability of occurrence, where a larger value corresponds to a stronger correlation of dataset points of the first dataset group with the CSI and a smaller value corresponds to a weaker correlation of dataset points of the first dataset group with the CSI; or classified based on an observable characteristic of the CSI that includes one or more of channel taps, a ratio of a maximum value of a singular value to a minimum value of the singular value of a channel matrix or a precoding matrix, or a power-delay profile associated with the CSI, or an unobservable characteristic of the CSI that is based on an observable characteristic; where the observable characteristic is one or more of a flag on whether a channel associated with the CSI corresponds to a LoS or NLOS channel based on a number of dominant basis indices of a transformed frequency-domain basis, the dominant basis indices corresponding to indices with a minimum power threshold; where the training dataset corresponds to positioning information, and where a first data group of the multiple data groups is at least one of: associated with one or more of a time stamp corresponding to a time of collection of the positioning information, a time of signaling data corresponding to the positioning information, a time interval at which the first dataset group is valid, or a value corresponding to one or more of a weight or a probability of occurrence, where a larger value corresponds to a stronger correlation of dataset points of the first dataset group with an actual position, and a smaller value corresponds to a weaker correlation of dataset points of the first dataset group with the actual position; or classified based on an observable characteristic of the position that includes one or more of an angle of arrival, an angle of departure, a round-trip time, or a time-difference of arrival, or an unobservable characteristic of the actual position that is based on an observable characteristic; where the observable characteristic is one or more of a flag on whether a channel associated with the positioning information corresponds to an indoor or outdoor UE based on one or more of the values of the angle of arrival, the angle of departure, the round-trip time, or the time-difference of arrival; where the training dataset corresponds to mobility information, and where a first dataset group of the multiple dataset groups is at least one of: associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, where a larger value corresponds to a stronger correlation of dataset points of the first dataset group with a heuristic cell association or selection, and a smaller value corresponds to a weaker correlation of dataset points of the first dataset group with the heuristic cell association or selection; or classified based on an observable characteristic of the UE mobility that includes one or more of RSRP, SINR, beam-based information, CSI, or an unobservable characteristic of the mobility information that is based on an observable characteristic; where the observable characteristic is a flag on whether the UE is associated with a best cell based on one or more of values of the RSRP, values of the SINR, beam-based information, or CSI.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

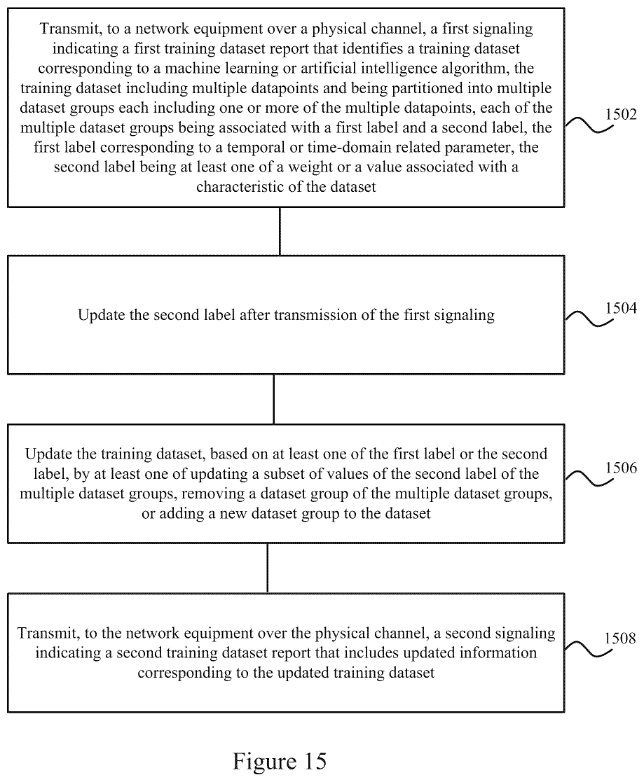

FIG. 15 illustrates a flowchart of a method in accordance with aspects of the present disclosure. The operations of the method may be implemented by a UE as described herein. In some implementations, the UE may execute a set of instructions to control the function elements of the UE to perform the described functions.

At 1502, the method may include transmitting, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset. The operations of 1502 may be performed in accordance with examples as described herein. In some implementations, aspects of the operations of 1502 may be performed by a UE as described with reference to FIG. 12.

At 1504, the method may include updating the second label after transmission of the first signaling. The operations of 1504 may be performed in accordance with examples as described herein. In some implementations, aspects of the operations of 1504 may be performed by a UE as described with reference to FIG. 12.

At 1506, the method may include updating the training dataset, based on at least one of the first label or the second label, by at least one of updating a subset of values of the second label of the multiple dataset groups, removing a dataset group of the multiple dataset groups, or adding a new dataset group to the dataset. The operations of 1506 may be performed in accordance with examples as described herein. In some implementations, aspects of the operations of 1506 may be performed a UE as described with reference to FIG. 12.

At 1508, the method may include transmitting, to the network equipment over the physical channel, a second signaling indicating a second training dataset report that includes updated information corresponding to the updated training dataset. The operations of 1508 may be performed in accordance with examples as described herein. In some implementations, aspects of the operations of 1508 may be performed a UE as described with reference to FIG. 12.

It should be noted that the method described herein describes a possible implementation, and that the operations and the steps may be rearranged or otherwise modified and that other implementations are possible.

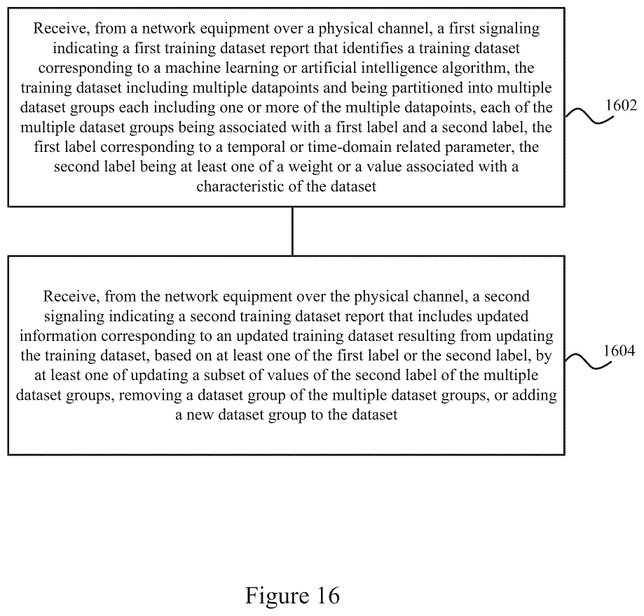

FIG. 16 illustrates a flowchart of a method in accordance with aspects of the present disclosure. The operations of the method may be implemented by a UE as described herein. In some implementations, the UE may execute a set of instructions to control the function elements of the UE to perform the described functions.

At 1602, the method may include receiving, from a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset. The operations of 1602 may be performed in accordance with examples as described herein. In some implementations, aspects of the operations of 1602 may be performed by a UE as described with reference to FIG. 12.

At 1604, the method may include receiving, from the network equipment over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset. The operations of 1604 may be performed in accordance with examples as described herein. In some implementations, aspects of the operations of 1604 may be performed by a UE as described with reference to FIG. 12.

It should be noted that the method described herein describes a possible implementation, and that the operations and the steps may be rearranged or otherwise modified and that other implementations are possible.

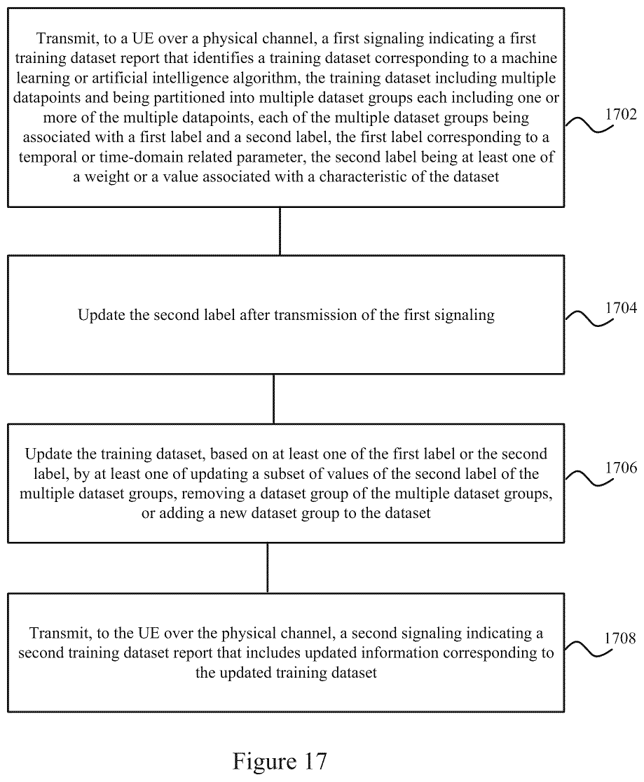

FIG. 17 illustrates a flowchart of a method in accordance with aspects of the present disclosure. The operations of the method may be implemented by a NE as described herein. In some implementations, the NE may execute a set of instructions to control the function elements of the NE to perform the described functions.

At 1702, the method may include transmitting, to a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset. The operations of 1702 may be performed in accordance with examples as described herein. In some implementations, aspects of the operations of 1702 may be performed by a NE as described with reference to FIG. 14.

At 1704, the method may include updating the second label after transmission of the first signaling. The operations of 1704 may be performed in accordance with examples as described herein. In some implementations, aspects of the operations of 1704 may be performed by a NE as described with reference to FIG. 14.

At 1706, the method may include updating the training dataset, based on at least one of the first label or the second label, by at least one of updating a subset of values of the second label of the multiple dataset groups, removing a dataset group of the multiple dataset groups, or adding a new dataset group to the dataset. The operations of 1706 may be performed in accordance with examples as described herein. In some implementations, aspects of the operations of 1706 may be performed a NE as described with reference to FIG. 14.

At 1708, the method may include transmitting, to the UE over the physical channel, a second signaling indicating a second training dataset report that includes updated information corresponding to the updated training dataset. The operations of 1708 may be performed in accordance with examples as described herein. In some implementations, aspects of the operations of 1708 may be performed a NE as described with reference to FIG. 14.

It should be noted that the method described herein describes a possible implementation, and that the operations and the steps may be rearranged or otherwise modified and that other implementations are possible.

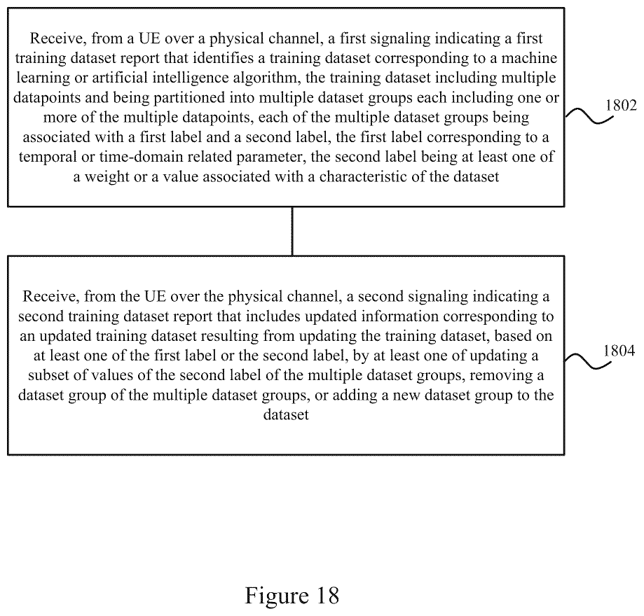

FIG. 18 illustrates a flowchart of a method in accordance with aspects of the present disclosure. The operations of the method may be implemented by a NE as described herein. In some implementations, the NE may execute a set of instructions to control the function elements of the NE to perform the described functions.

At 1802, the method may include receiving, from a UE over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset. The operations of 1802 may be performed in accordance with examples as described herein. In some implementations, aspects of the operations of 1802 may be performed by a NE as described with reference to FIG. 14.

At 1804, the method may include receiving, from the UE over the physical channel, a second signaling indicating a second training dataset report that includes updated information corresponding to an updated training dataset resulting from updating the training dataset, based on at least one of the first label or the second label, by at least one of updating a subset of values of the second label of the multiple dataset groups, removing a dataset group of the multiple dataset groups, or adding a new dataset group to the dataset. The operations of 1804 may be performed in accordance with examples as described herein. In some implementations, aspects of the operations of 1804 may be performed by a NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset;
update the second label after transmission of the first signaling;
update the training dataset, based on at least one of the first label or the second label, by at least one of updating a subset of values of the second label of the multiple dataset groups, removing a dataset group of the multiple dataset groups, or adding a new dataset group to the dataset; and
transmit, to the network equipment over the physical channel, a second signaling indicating a second training dataset report that includes updated information corresponding to the updated training dataset.

2. The UE of claim 1, wherein the physical channel is an uplink channel.

3. The UE of claim 1, wherein a number of the multiple dataset groups is bounded by a maximum value of a number of dataset groups.

4. The UE of claim 1, wherein the temporal or time-domain related parameter is at least one of a time stamp or a time duration.

5. The UE of claim 1, wherein the first label is one of:
a time duration that comprises parameters corresponding to at least one of a start time, or a time interval and a time periodicity;
a time stamp that corresponds to one of a time of transmission of the datapoints of a dataset group, or a time of collection of the datapoints of the dataset group; or
a combination thereof.

6. The UE of claim 1, wherein the weight of the dataset group is selected from a codebook of values associated with the weight.

7. The UE of claim 1, wherein the weight of the dataset group is updated based on an event, and the event is:
based on a configuration for updating the dataset, one of a periodic or a semipersistent event;
triggered by at least one of a network configuration signal, a downlink control information, or a medium access control element (MAC-CE) signal;
or a combination thereof.

8. The UE of claim 1, wherein a dataset group associated with a time stamp corresponding to a former value is replaced with a dataset group associated with a time stamp corresponding to a more recent value.

9. The UE of claim 1, wherein a dataset point is associated, based on one or more characteristics of the dataset point, with a dataset group of the multiple dataset groups.

10. The UE of claim 9, wherein a characteristic in the one or more characteristics of the dataset point is an observable characteristic that is derived via at least one of:
a deterministic formula of a value of the dataset point;
a transformed variant of the value of the dataset point based on a transformation operation; or
a normalization of the value of the dataset point with respect to one or more values of other dataset points.

11. The UE of claim 9, wherein the characteristic in the one or more characteristics of the dataset point is an unobservable characteristic that corresponds to at least one of:
a parameter that identifies whether the dataset point is classified as an outlier or a common point;
a statistical correlation parameter corresponding to an approximate distribution associated with the dataset; or
a parameter corresponding to a power-delay profile corresponding to an approximate distribution associated with the dataset.

12. The UE of claim 1, wherein the training dataset corresponds to at least one of channel state information (CSI), precoding information, or beam-based information, and wherein a first dataset group of the multiple dataset groups is at least one of:
associated with one or more of a time stamp corresponding to a time of collection of the CSI, a time of signaling data corresponding to the CSI, a time interval at which the first dataset group is valid, or a value corresponding to one or more of a weight or a probability of occurrence, wherein a larger value corresponds to a stronger correlation of dataset points of the first dataset group with the CSI and a smaller value corresponds to a weaker correlation of dataset points of the first dataset group with the CSI; or
classified based on an observable characteristic of the CSI that includes one or more of channel taps, a ratio of a maximum value of a singular value to a minimum value of the singular value of a channel matrix or a precoding matrix, a power-delay profile associated with the CSI, or an unobservable characteristic of the CSI that is based on an observable characteristic.

13. The UE of claim 12, wherein the observable characteristic is one or more of a flag on whether a channel associated with the CSI corresponds to a line-of-sight (LoS) or non-line-of-sight (NLoS) channel based on a number of dominant basis indices of a transformed frequency-domain basis, the dominant basis indices corresponding to indices with a minimum power threshold.

14. The UE of claim 1, wherein the training dataset corresponds to positioning information, and wherein a first dataset group of the multiple dataset groups is at least one of:
associated with one or more of a time stamp corresponding to a time of collection of the positioning information, a time of signaling data corresponding to the positioning information, a time interval at which the first dataset group is valid, or a value corresponding to one or more of a weight or a probability of occurrence, wherein a larger value corresponds to a stronger correlation of dataset points of the first dataset group with an actual position, and a smaller value corresponds to a weaker correlation of dataset points of the first dataset group with the actual position; or
classified based on an observable characteristic of the position that includes one or more of an angle of arrival, an angle of departure, a round-trip time, or a time-difference of arrival, or an unobservable characteristic of the actual position that is based on an observable characteristic.

15. The UE of claim 14, wherein the observable characteristic is one or more of a flag on whether a channel associated with the positioning information corresponds to an indoor or outdoor UE based on one or more of the values of the angle of arrival, the angle of departure, the round-trip time, or the time-difference of arrival.

16. The UE of claim 1, wherein the training dataset corresponds to mobility information, and wherein a first dataset group of the multiple dataset groups is at least one of:
associated with one or more of a time stamp corresponding to a time of collection of the mobility information or cell association information, a time of signaling data corresponding to the cell association, a time interval at which the first dataset group is valid, or a value corresponding to one or more of a weight or a probability of occurrence, wherein a larger value corresponds to a stronger correlation of dataset points of the first dataset group with a heuristic cell association or selection, and a smaller value corresponds to a weaker correlation of dataset points of the first dataset group with the heuristic cell association or selection; or
classified based on an observable characteristic of the UE mobility that includes one or more of reference signal received power (RSRP), signal-to-interference-and-noise ratio (SINR), beam-based information, channel state information (CSI), or an unobservable characteristic of the mobility information that is based on an observable characteristic.

17. The UE of claim 16, wherein the observable characteristic is a flag on whether the UE is associated with a best cell based on one or more of values of the RSRP, values of the SINR, beam-based information, or CSI.

18. A base station for wireless communication, comprising:
at least one memory; and
at least one processor coupled with the at least one memory and configured to cause the base station to:
transmit, to a user equipment (UE) over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset;
update the second label after transmission of the first signaling;
update the training dataset, based on at least one of the first label or the second label, by at least one of updating a subset of values of the second label of the multiple dataset groups, removing a dataset group of the multiple dataset groups, or adding a new dataset group to the dataset; and
transmit, to the UE over the physical channel, a second signaling indicating a second training dataset report that includes updated information corresponding to the updated training dataset.

19. A processor for wireless communication, comprising:
at least one controller coupled with at least one memory and configured to cause the processor to:
transmit, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset;
update the second label after transmission of the first signaling;
update the training dataset, based on at least one of the first label or the second label, by at least one of updating a subset of values of the second label of the multiple dataset groups, removing a dataset group of the multiple dataset groups, or adding a new dataset group to the dataset; and
transmit, to the network equipment over the physical channel, a second signaling indicating a second training dataset report that includes updated information corresponding to the updated training dataset.

20. A method performed by a user equipment (UE), the method comprising:
transmitting, to a network equipment over a physical channel, a first signaling indicating a first training dataset report that identifies a training dataset corresponding to a machine learning or artificial intelligence algorithm, the training dataset including multiple datapoints and being partitioned into multiple dataset groups each including one or more of the multiple datapoints, each of the multiple dataset groups being associated with a first label and a second label, the first label corresponding to a temporal or time-domain related parameter, the second label being at least one of a weight or a value associated with a characteristic of the dataset;
updating the second label after transmission of the first signaling;
updating the training dataset, based on at least one of the first label or the second label, by at least one of updating a subset of values of the second label of the multiple dataset groups, removing a dataset group of the multiple dataset groups, or adding a new dataset group to the dataset; and
transmitting, to the network equipment over the physical channel, a second signaling indicating a second training dataset report that includes updated information corresponding to the updated training dataset.
